(19) United States
(12) Patent Application Publication
(10) Pub. No.: US 2002/0118891 A1
(43) Pub. Date: Aug. 29, 2002

(54) Object based cursors for scan area selection

(76) Inventors: Michael L. Rudd, Fort Collins, CO (US); Jerlyn R. Culp, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/794,849

(22) Filed: Feb. 27, 2001

(51) Int. Cl. G06K 9/20; G06K 9/36; G06K 9/03

(52) U.S. Cl. 382/282; 382/311

(57) ABSTRACT

The present invention provides a system for making single, merged digital images including a processor configured to provide a digital image, a monitor configured to display the digital image, a user input device configured to accept commands from a user and software associated with the processor. The software is configured for providing at least one object cursor capable of receiving a selected portion of the digital image when overlaid on the digital image, wherein the software is also configured to merge the object cursor and selected portion of the digital image into a single image.

### BACKGROUND

The use of scanned images and computer technology to create fin, amusing and artistic pictures, cards, and other items is known in the art. For example, some computer users make novelty or gag items by combining a portion of an image of a friend or acquaintance with an image of a famous place or setting to create a composite image of the person in that setting, which would appear genuine if the viewer did not know better. For example, some computer users find it amusing to make a fake dollar bill that would appear real if not for the fact that it has the head of a friend or acquaintance in place of the portrait of George Washington.

As will be appreciated by one of ordinary skill in the art, the process of creating composite images is complex, time consuming, and beyond the skill of the typical computer user. For example, to make a novelty dollar bill incorporating the portrait of a person taken from a second image, the user must first scan the image of a dollar bill into a computer system and also scan in the photograph of the target individual. Scanning suitable images for creating a composite image often proves difficult and time consuming. For example, a user must figure out the appropriate size of the picture to scan in order to get the two images to match on a similar size scale to help create the illusion of authenticity (which is essential to the effectiveness of the novelty item). With today's scanner technology, the user has no way to preview how the images will fit prior to scanning.

Next, the user must open image editing software and painstakingly cut out the head of the target individual from the scanned picture and cut out the portrait of George Washington from the image of the dollar bill. Cutting out the images is exceedingly difficult and causes many users to abandon their projects after repeated failures. As will be appreciated by anyone who has ever tried to use the “lasso tool” from a clip art tool bar, it is nearly impossible to free-hand draw two identical size images; it is exceedingly difficult to cut a portion from one image and place it in an identically sized hole cut in a second image.

The lack of stencils or overlays to use with a scanned picture makes today's requirement that the user cut two identically sized images prohibitive for all but the simplest settings. The prior art has attempted to overcome the need for identical image cutting by providing a background on which a scanned image can be placed to create a composite image such as a novelty item. For example, a greeting card background or a fake magazine cover capable of having a scanned imaged placed on top (and then printed out) may be provided. However, these set-backgrounds and overlay items suffer from many of the same drawbacks. For example, the user must scan an image of a suitable size for placement on the background in a fashion that looks realistic to a viewer. Likewise, the user is forced to use image editing tools to crop the photo to include only the portions needed to create the desired visual illusion. Typical prior art set-background devices and methods, such as those disclosed in U.S. Pat. Nos. 5,459,819; 6,005,972; and 6,123,362, simply provide an area which receives an image and do not seek to allow editing of the image or background to match size or color.

With prior art processes, even in the event a user succeeds in cutting matching portions of the images and succeeds in pasting the cropped photograph on the image, numerous other obstacles hinder the process. For example, even assuming the size of the images are a suitable match, the color of the images may not match, thereby taking away from the desired illusion of authenticity of the end image. Furthermore, the absence of editing tools capable of providing authentic coloring or shading to the end image prevents all but the most basic black and white composite images from appearing suitably authentic. Tinting and coloration problems may also be a drawback to certain set-background illusions. As will be appreciated by one of ordinary skill in the art, the technology using set-backgrounds for novelty items does not offer substantial image editing capabilities. For example, in addition to tinting and coloring problems, size editing proves difficult because the image resized is resized about a central axis of the computer screen without regard for the position of the other image. In other words, each time the image is centered in the background and then resized, the image moves off-center and must be repositioned.

### SUMMARY OF THE INVENTION

The present invention overcomes many of the practical problems described above and offers new advantages as well. The present invention is based, in part, on the discovery that the provision of object cursors adapted to receive a portion of a digital image and then merging the object cursor and the received portion of the digital image into a single digital image is capable of producing merged or composite images without requiring the user to tediously edit, crop and balance the constituent images to form a result that appears authentic.

According to one aspect of the invention there is provided a system for making single, merged digital images including a processor configured to provide a digital image, a monitor configured to display the digital image, a user input device configured to accept commands from a user and software associated with the processor. According to this aspect of the invention, the software is configured for providing at least one object cursor capable of receiving a selected portion of the digital image when overlaid on the digital image, wherein the software is also configured to merge the object cursor and selected portion of the digital image into a single composite image.

According to another aspect of the invention, there is provided a method of making a composite digital image, e.g., a novelty item, including the steps of acquiring a digital image, overlaying an object cursor having a cursor window over the digital image such that a desired portion of the digital image appears in the cursor window, and merging the cursor and the desired portion of the digital image into a single image.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope in the invention as set forth in the appended claims.

### BRIEF DESCRIPTION OF THE DRAWING

For a more complete understanding of the present invention, reference is now made to the following descriptions taken in conjunction with the accompanying drawing, in which:

FIG. 1 is a block diagram of an imaging station according to an embodiment of the invention;

FIG. 2 is a display showing an object cursor and a digitized photograph according to the invention;

FIG. 3 is a depiction of the object cursor of FIG. 2 overlaying the digitized image prior to resizing;

FIG. 4 is a depiction of the object cursor of FIG. 2 overlaying the digitized image after sizing;

FIG. 5 is a plan view of a composite image according to the invention;

FIG. 6 is a flow chart of a method of making a novelty item according to the invention;

FIG. 7 is a display of another embodiment of an object cursor and a digitized photograph according to the invention;

FIG. 8 is a depiction of the object cursor of FIG. 7 overlaying the digitized image prior to editing according to the invention;

FIG. 9 is a depiction of the object cursor of FIG. 7 overlaying the digitized image after editing according to the invention; and

FIG. 10 is a depiction of the object cursor and digitized image of FIG. 9 wherein the cursor window background color has been edited.

### DETAILED DESCRIPTION

While the present invention is described in connection with composite images for novelty items, it will be readily appreciated by one of ordinary skill in the art that the apparatuses, methods and teachings of the present invention can be applied to other fields and industries where composite images are used. For example, the present image may be useful in the manufacturing of identification badges and the like. Accordingly, the invention should not be viewed as being limited to any particular product or industry.

In accordance with a presently preferred embodiment, FIG. 1 depicts a computer system 100 configured for creating composite images to form novelty items. As shown in FIG. 1, computer system 100 comprises processor 101 interfaced with video monitor 102 and user input device 103. Video monitor 102 allows a user to view images generated by processor 101. User input device 103, which preferably comprises a mouse and/or keyboard (not shown), allows a user to interact with images on the screen and to enter commands to operate computer system 100.

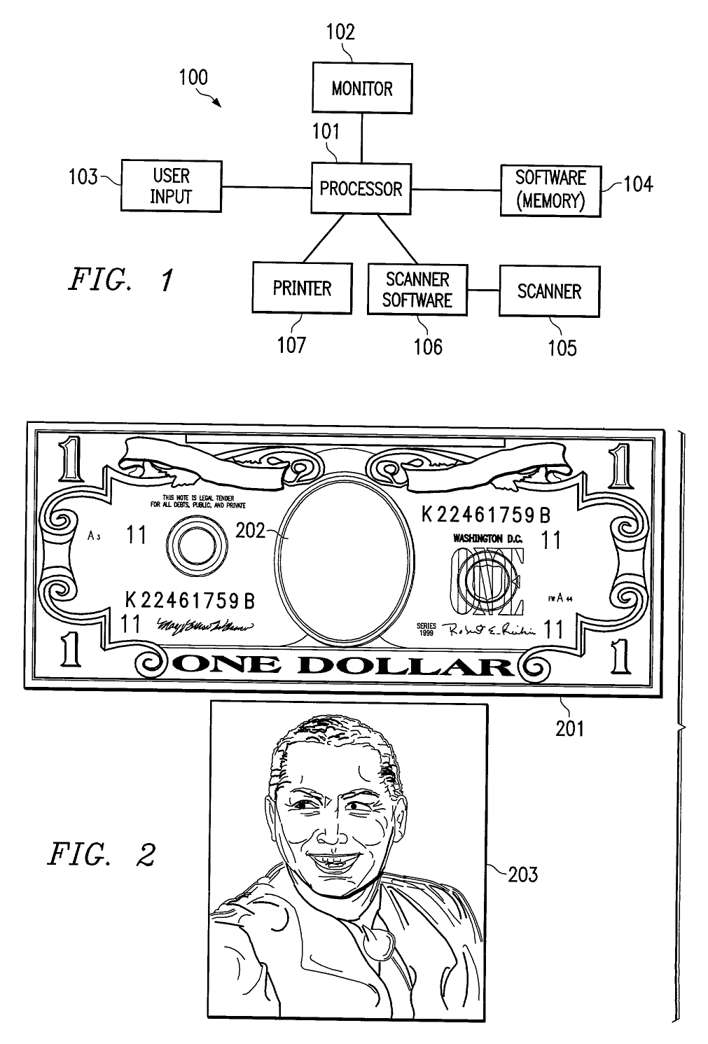

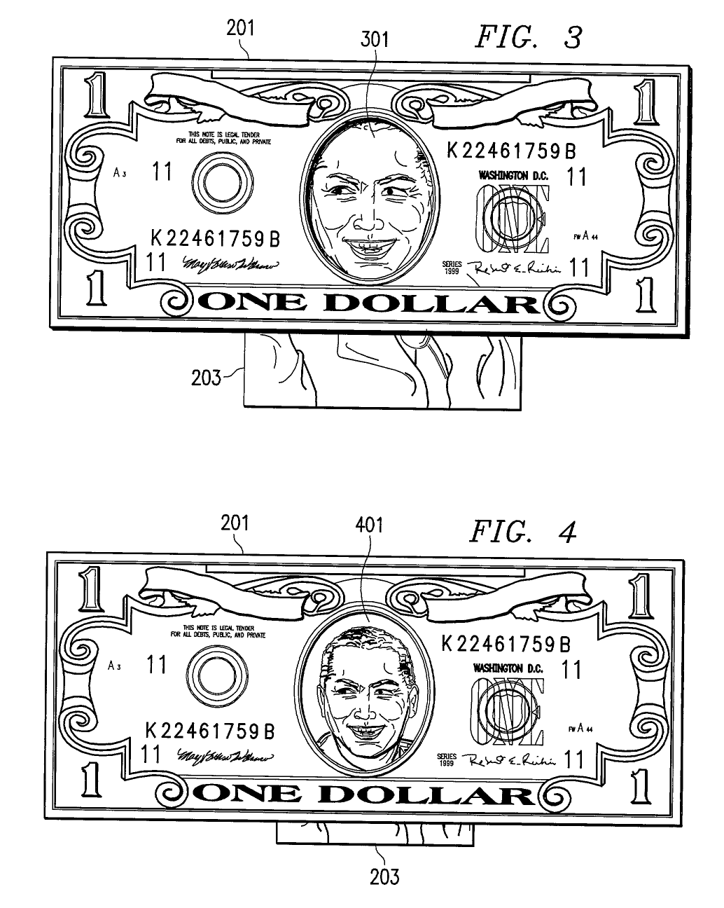

Processor 101 has software 104 configured to generate object masks, preferably in the form of “cursors,” such as dollar bill template 201 depicted in FIG. 2. Object cursors are computer generated images, or templates, which have a window area adapted for accepting a portion of another digital image. For example, dollar bill template 201 depicted in FIG. 2 has cursor window 202. Cursor window 202 is a blank area which allows a user to place template 201 over digital image 203, as shown in FIG. 3, to get centered overlay image 301. User maneuvers template 201 and/or digital image 203 until desired portion of digital image 401 appears through cursor window 202, as depicted in FIG. 4. In operation, user maneuvers template 201 over digital image 203 to get centered overlay image 301. User then resizes centered overlay image 301 to reveal only desired portion of digital image 401. In resizing, the digital image 203 is preferably resized such that the image remains centered in cursor window 202 as opposed to being resized without regard for the location of cursor window 202.

The combined image 400 is then merged to form composite image 500, as depicted in FIG. 5, comprising a single, merged digital image of template 201 and desired portion of digital image 401. Composite image 500 may then be sent electronically to others or printed by printer 107 and distributed if desired.

As will be appreciated by one of ordinary skill in the art, software 104 may provide image manipulation functionality according to the invention. Preferably, software 104 interfaces with scanner software 106 to capture a low resolution preview scan of digital image 203, define desired portion of digital image 401 to be scanned using high resolution, and combine the cursor and scanned images to form composite image 500.

It will also be appreciated that object based cursors can be provided with a cursor window, or a plurality of cursor window areas, in any area of the object based cursors. Presently preferred object based cursors, include, but by no means are limited to, a piece of currency, Mt. Rushmore, a magazine or newspaper cover, a greeting card, a motor vehicle, a person, a place, an animal, and/or a movie scene.

Software 104 is preferably configured to allow a user to select and manipulate object cursors using user input 103. Preferably, a user may select a desired object cursor using a mouse by clicking on a tool bar of available cursors, or alternatively, by manipulating pull down menus to highlight and select a desired object cursor. Alternatively, a code command can be assigned to each available cursor, whereby a user enters the code to select the desired object cursor.

In a preferred embodiment, once an object cursor is selected, the user's mouse cursor on screen of monitor 102 takes the form of the object cursor and may be moved and manipulated by movement of the mouse and/or typing of commands.

Software 104 is also preferably configured to allow a user to alter or edit images viewed on screen of monitor 102. Altering or editing images may comprise manipulation of image size (zoom in/zoom out), image orientation, image color and image editing (i.e., allow a user to use an image editing program), cropping, etc. For example, the user may need to zoom in or zoom out the object cursor and/or image to make the final image look realistic to scale. Likewise, the user may need to edit or later the contrast, density, brightness, color parameters or other characteristics of the object cursor and/or image to make the final image appear authentic. For example, to make a novelty dollar bill appear more realistic, the digital image may need to be tinted to the same shade of green as the object cursor.

Software 104 may be configured to allow altering or editing to occur at any point in the creation process. Likewise, the software 104 may provide that the object cursor and/or digital image and/or final merged digital image be edited or altered. Software 104 may also be configured to automatically adjust images to aid the formation of an authentic-looking composite image 500. For example, software 104 may automatically tint the shade of desired portion of digital image 401 to match that of template 201 to make an authentic-looking novelty dollar bill, crop the inserted image and add a suitable background and/or overlay etc.

Other examples of image editing or altering include the blending or fading of the edges of the cursor and image in the window to aid the authentic-appearance of the final image. These kind of image editing or altering techniques may be manual, or preferably, performed automatically as part of the program, or “knowledge”, of a specific cursor.

Digital image 203 may be provided by any suitable source. For example, a user may download an image from the Internet for use with the system 100. In a presently preferred embodiment, digital image is provided by means of scanner 105 and scanner software 106.

Scanner 105 and scanner software 106 may be any suitable type capable of optically scanning an object and generating a digital image of the object. In a presently preferred embodiment, digital image 203 is generated by scanner 105 and scanner software 106 having a “preview scan” mode. Details concerning the preview scan mode are set forth in U.S. Pat. No. 6,151,426, which is hereby incorporated by reference in its entirety.

According to this embodiment, the system 100 is configured to allow a user to perform a preview scan of a picture placed on scanner bed of scanner 105. A low resolution digital image 203 is presented on screen of monitor 102. User accesses software 104 to select a desired object cursor, such as dollar bill template 201. The user then maneuvers object cursor 201 until centered overlay image 301 appears in cursor window 202. Centered overlay image 301 is resized to reveal only desired portion of digital image 401. Any necessary editing of the template 201, centered overlay image 301, or desired portion of digital image 401 may be performed to aid the authenticity of composite image 500 at any time in the process. For example, the size of the image may be adjusted, while a predetermined point of the image is automatically centered in the image window. The background color of the image may also be adjusted to better merge into the cursor image. The adjusting may be manually or automatically done.

The user then performs a final scan, preferably at a higher resolution than preview scan, to merge the cursor image data with the data of the portion of the digital image appearing through cursor window to generate a single, merged digital image or composite image 500, which may then be sent electronically or printed for the enjoyment of others or for other reasons.

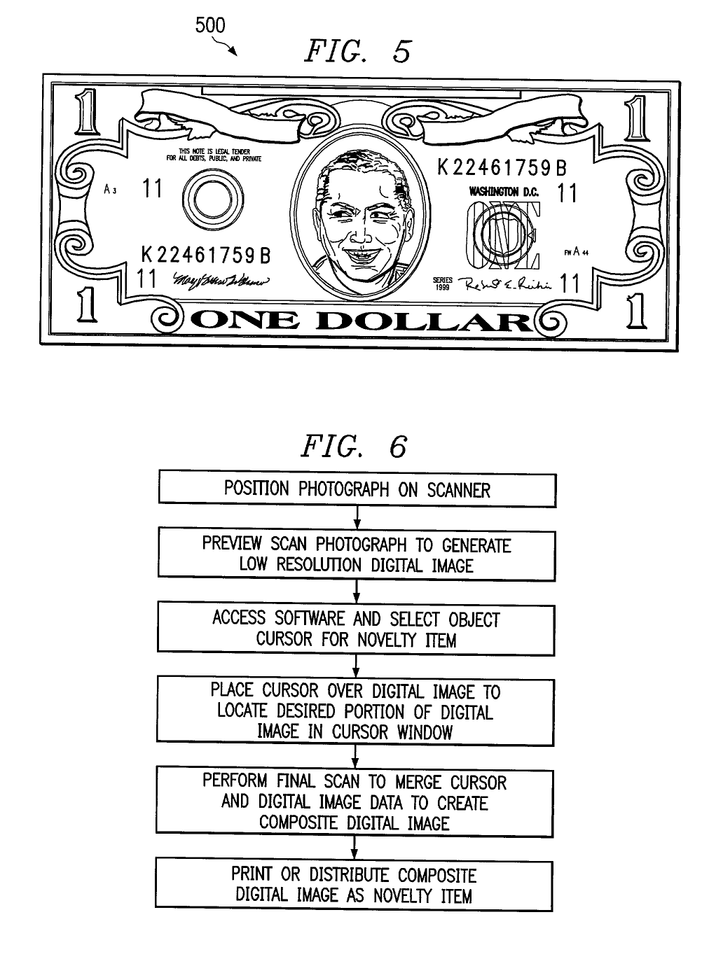

FIG. 6 depicts a flow chart of a presently preferred method of composing a composite image. As depicted, in operation, a user places a photograph on the bed of a scanner. The user then performs a low resolution preview scan of the photograph to generate a digital image. The user then accesses a desired object cursor. The user overlays the object cursor and edits in a manner such that only a desired portion of the digital image is visible in the cursor window. The user then performs a final scan to merge the object cursor data and visible portion of digital image into a single merged image. The merged image may then be distributed by any suitable means for any use, e.g., as a novelty item for the enjoyment of others.

In an alternative method, multiple object cursors may be used. For example, a user may select an object cursor of George Washington's hair and clothing as it appears on a dollar bill and overlay the cursor on a digital image of a person. The user may then correctly size, tint, or otherwise alter or edit the combined image to mimic the portrait of George Washington as it appears on a one dollar bill. The user then selects a second object cursor, such as a dollar bill template, and overlays the template over the portrait and correctly sizes the portrait if necessary (or otherwise alters or edits the portrait as desired), and then merges the images into a single image.

As will be appreciated by one of ordinary skill in the art with knowledge of the present specification, altering and editing of the images can be performed at any suitable step in the process. Also, as will be appreciated, the high resolution final scan of only the portion of the picture on the scanner bed which appears through the cursor window results in a significant decrease in the amount of data to be downloaded and the amount of data to be downloaded adn the amount of time scanning will take. For example, if a picture on the user's scanner bed is 8×10 but only a 1×1 portion is to be scanned, the fact that there was not enough time or memory to scan the entire 8×10 image becomes irrelevant.

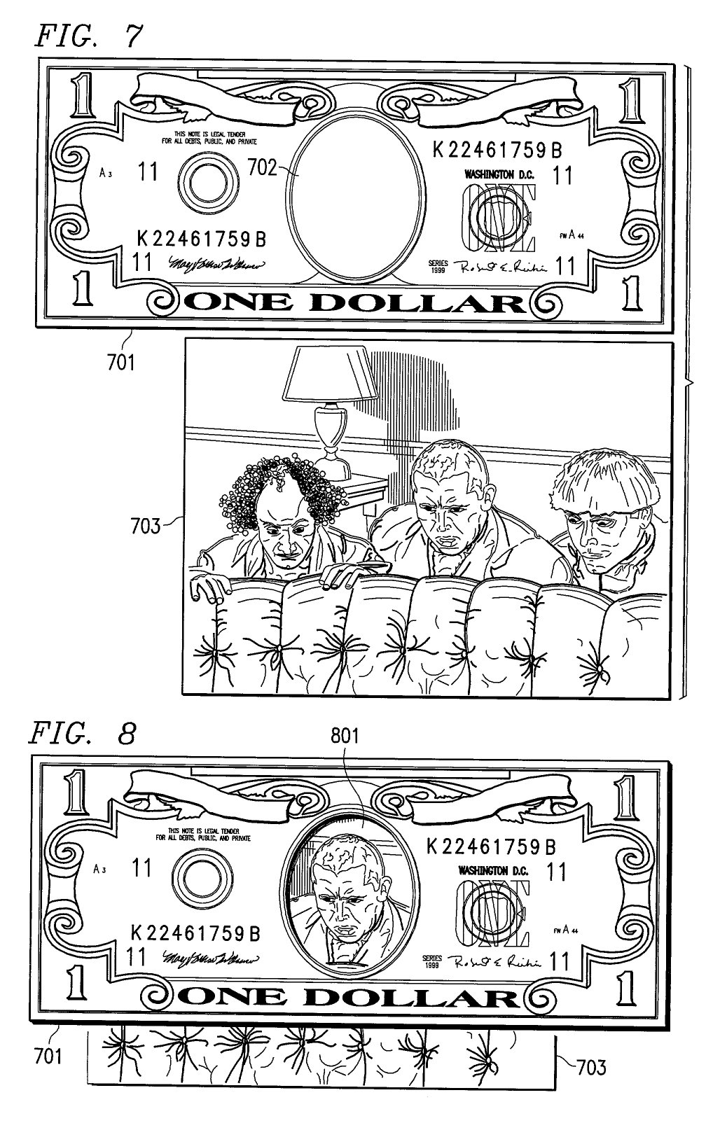

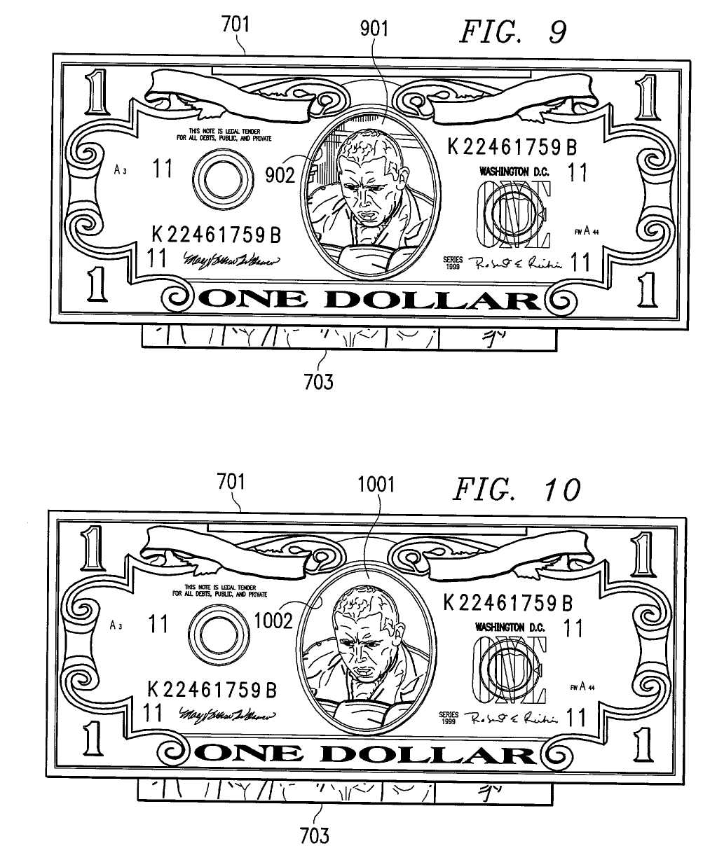

FIGS. 7-10 depict a variation of the embodiment described above. As shown in FIG. 7, modified dollar bill template 701 has a modified cursor window 702 for overlaying on new digital image 703. By contrast with cursor window 202, which was clear for insertion of an opaque portion of digital image 203, modified cursor window 702 includes a background image for use with a partially transparent image or a background for use with a closely cropped image that does not occupy the entire area of the window. To illustrate, FIG. 8 depicts modified template 701 overlaying new digital image 703 such that centered overlay image 801 occupies modified cursor window 702. FIG. 9 depicts a cropped portion of digital image 901 and background 902 occupying modified cursor window. Cropped portion 901 represents the sizing and cropping of centered overlay image 801 to a suitable size and orientation, while background 902 represents the preexisting shading or set background of modified cursor window 702. As shown in FIG. 10, the background 902 may be further modified or edited to create final background 1002 to aid the appearance of the ultimate composite image to be formed. Final background 1002 is preferably edited prior to final scanning to aid the appearance of the ultimate composite image. As shown in FIG. 10, final background 1002 may simply reflect the removal of color or addition of tinting to aid the authenticity of the final image; or alternatively reflect tinting to cover undesired portions of new digital image 703 originally present within modified cursor window 702.

It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

What is claimed is:

1. A system for making single, merged digital images, comprising:
a processor configured to provide a digital image;
a monitor configured to display said digital image;
a user device input configured to accept commands from a user; and
software associated with said processor, said software configured for providing at least one object cursor capable of receiving a selected portion of said digital image when overlaid on said digital image, wherein said software is further configured for merging said object cursor and said selected portion of said digital image into a single image.

2. The system of claim 1 wherein said selected portion of said digital image is received in a cursor window of said object cursor.

3. The system of claim 1 wherein said object cursor comprises a template having a cursor window defined therein, and wherein said selected portion of said digital image appears in said cursor window.

4. The system of claim 3 wherein said object cursor is selected by a user using said user input device to select said object cursor from a plurality of object cursors provided by said software.

5. The system of claim 1 further comprising:
an optical scanner, wherein said scanner optically scans an object to create said digital image.

6. The system of claim 5 further comprising:
scanner software associated with said scanner, said scanner software configured to cause said scanner to perform a low resolution scan of said object to create said digital image and configured to cause said scanner to perform a higher resolution scan to merge said cursor 5 and said selected portion of said digital image.

7. The system of claim 1 wherein said software allows a user to edit at least one of the appearance of said cursor and said digital image.

8. The system of claim 7 wherein said editing comprises resizing said digital image about a point relative to a geometry of said cursor window.

9. The system of claim 1 wherein said software automatically edits at least one of the appearance of said cursor and said digital image.

10. The system of claim 1 wherein said software allows at least one of said cursor and said digital image to be edited during at least one of before and after merging.

11. A method of making a novelty item comprising:
overlaying an object cursor having a cursor window over a digital image, said object cursor being positionable over said digital image such that a desired portion of said digital image appears in said cursor window; and
merging said cursor and said desired portion of said digital image into a single image.

12. The method of claim 11 further comprising the step of editing at least one of the appearance of said cursor and said digital image.

13. The method of claim 12 wherein the editing step is performed prior to the merging step.

14. The method of claim 12 wherein the editing step is performed after the merging step.

15. A method making a single, merged digital image, comprising:
acquiring a digital image;
overlaying an object based cursor having a cursor window over said digital image such that a desired portion of said digital image appears in said cursor window; and
merging said cursor and said desired portion of said digital image to create a single, merged digital image.

16. The method of claim 15 wherein said acquiring step comprises:
preview scanning an object with a scanner to produce a low resolution digital image.

17. The method of claim 15 further comprising the step of editing at least one of the appearance of said cursor and said digital image prior to said merging step.

18. The method of claim 15 further comprising the step of editing the appearance of said single, merged digital image.

19. The method of claim 15 wherein said merging step comprises the step of high resolution scanning of only the area of said object corresponding to said desired area of said digital image.

20. The method of claim 19 further comprising the step of outputting the merged image which includes at least one of printing and electronically transmitting said merged image.
